(19) United States
(12) Patent Application Publication
(10) Pub. No.: US 2020/0025994 A1
(43) Pub. Date: Jan. 23, 2020

(54) LIGHT GUIDE PLATE AND DISPLAY DEVICE

(71) Applicants: HKC Corporation Limited, Shenzhen (CN); Chongqing HKC Optoelectronics Technology Co., Ltd., Chongqing (CN)

(72) Inventor: Jiahe Cheng, Shenzhen (CN)

(21) Appl. No.: 16/293,657

(22) Filed: Mar. 6, 2019

Related U.S. Application Data
(63) Continuation of application No. PCT/CN2018/124434, filed on Dec. 27, 2018.

(30) Foreign Application Priority Data
Jul. 17, 2018 (CN) 201821130900.8

(51) Int. Cl. F21V 8/00

(52) U.S. Cl. CPC G02B 6/0043; G02B 6/0055; G02B 6/0036; G02B 6/0065

(57) ABSTRACT

The embodiment of the present application discloses a light guide plate and a display device, belonging to the technical field of display. The light guide plate is used for a display device. The light guide plate includes a main body, a light incident surface at a lateral side of the main body and a light emitting surface at the top of the main body, and bubbles are formed in the main body.

### CROSS REFERENCE TO RELATED APPLICATIONS

The present application is a Continuation Application of PCT Application No. PCT/CN2018/124434 filed on De. 27, 2018, which claims the benefit of Chinese Patent Application No. 201821130900.8, filed with the Chinese Patent Office on Jul. 17, 2018 and entitled “Light Guide Plate and Display Device”, which is incorporated herein by reference in its entirety.

### TECHNICAL FIELD

The present application relates to the technical field of display, in particular, to a light guide plate and a display device with the same.

### BACKGROUND

At present, in the field of display, a light guide plate is usually combined with side-in light source to get a surface light source. Light emitted by the side-in light source enters the light guide plate from the light entry surface on one side of the light guide plate, and is emitted from the light emitting surface of the light guide plate after being emitted and diffused by the light guide spot on the light guide plate, to provide light for the panel to work.

However, in order to make full use of the light source emitted by the LED and make most of its light enter into the light guide plate, the light guide plate demands a certain thickness, resulting in an increasing thickness of the display, which is not in line with the current trend of a weight-reduced display.

### SUMMARY

In order to solve the aforementioned problems, the embodiment of the present application provides a light guide plate and a display device.

In order to achieve the aforementioned objective, the present application provides a light guide plate for a display device. The light guide plate includes a main body, a light incident surface at a lateral side of the main body and a light emitting surface at the top of the main body, and bubbles are formed in the main body.

Regarding the light guide plate, bubbles in the main body are uniformly distributed, and diameters of the bubbles are 0.1 mm to 2 mm. The volume ratio of the bubbles to the main body is 1:9 to 4:6.

The main body includes bubbles making the light guide plate have a hollow structure. In a direction perpendicular to the light emitting surface, the bubbles are circular or rectangular, and the bubbles are defined at the center of the main body.

The light guide plate includes a reflective surface defined opposite to the light emitting surface. A center line of the bubbles are centrally defined between the reflective surface and the light emitting surface, or is defined offset towards a direction of the reflective surface. A thickness of the bubbles is 0.1 mm to 3 mm between the reflective surface and the light emitting surface.

The light guide plate includes a reflective surface defined opposite to the light emitting surface. The bubbles in the main body are located on a same plane. The plane is paralleled to the light emitting surface, close to the reflective surface and away from the light emitting surface. Diameters of the bubbles are 0.3 mm to 1.5 mm. A volume ratio of the bubbles to the main body is 1:9 to 3:7.

The light guide plate includes a reflective surface defined opposite to the light emitting surface. The bubbles in the main body are defined on two mutually paralleled planes between the light emitting surface and the reflective surface. The two mutually paralleled planes are paralleled to the light emitting surface and the reflective surface. The two mutually paralleled planes are close to the reflective surface and away from the light emitting surface. Diameters of the bubbles are 0.1 mm to 1.5 mm. A volume ratio of the bubbles to the main body is 1:9 to 4:6.

The main body includes a central region and a peripheral region surrounding the central region. Bubbles located in the peripheral region are distributed denser than bubbles located in the central region. Diameters of the bubbles are 0.1 mm to 1.5 mm. The central region is in a symmetrical pattern or a specific pattern.

A volume ratio of the bubbles in the peripheral region is 2:8 to 3:7. A volume ratio of the bubbles in the central region is 1:9 to 2:8.

A distance is defined between the bubbles in the main body and the light incident surface and the distance is 2 to 10 mm. The central region is rectangular or circular.

In order to achieve the aforementioned objective, the present application provides a light guide plate including:

a main body in which bubbles are formed for reducing weight and atomizing light;

a light incident surface located at a lateral side of the main body; and

a light emitting surface located at the top of the main body;

the bubbles are formed by a foaming agent.

In order to achieve the aforementioned objective, the present application provides a display device including any of the light guide plates described above.

Compared with the prior art, bubbles are formed in the main body of the light guide plate provided by the embodiment of the present application, and the configuration of the bubbles can reduce the weight of the light guide plate without reducing the thickness of the light guide plate. The thickness of the light guide plate remains unchanged, and most of the light emitted by the light emitting unit can still enter the light guide plate, and bubbles are defined in the main body of the light guide plate. The present application can reduce the weight of the light guide plate without reducing the thickness of the light guide plate by forming bubbles in the main body of the light guide plate. In addition, the bubbles can destroy the total reflection of light in the main body and produce an atomized light-emitting effect. More light is thus uniformly emitted from the light emitting surface at the top of the light guide plate. The display device provided by the present application is light-weighted and meets the requirement of weight reduction of the display device. In addition, the bubbles in the light guide plate have the function of atomizing light, so that a light source is formed with more uniformed atomization on the light emitting surface, improving the display uniformity.

### BRIEF DESCRIPTION OF THE DRAWINGS

The drawings described herein are used to provide a further understanding of the embodiments of the present application and form part of the embodiments of the present application. The illustrative embodiments of the present application and the description thereof are used to explain the present application and do not constitute limitation of the present application. In the drawings:

FIG. 1 is a schematic diagram of the display device in some embodiment of the present application;

FIG. 2 is a schematic diagram of the display device in another embodiment of the present application;

FIG. 3 is a schematic diagram of the display device in another exemplary embodiment of the present application;

FIG. 4 is a schematic diagram of the display device in another exemplary embodiment of the present application;

FIG. 5 is a schematic diagram of the display device in another exemplary embodiment of the present application;

FIG. 6 is a schematic diagram of the light guide plate in the display device of FIG. 5;

FIG. 7 is a schematic diagram of the display device in another exemplary embodiment of the present application;

FIG. 8 is a schematic diagram of the light guide plate in the display device of FIG. 7.

### REFERENCE NUMERALS

100a—display device;

10a—light source module; 11a—light emitting unit; 12a—circuit board; 20a—backplane;

30a—light guide plate; 31a—main body; 311a—bubbles;

32a—light incident surface; 33a—light emitting surface; 34a—reflective surface.

100b—display device;

10b—light source module; 11b—light emitting unit; 12b—circuit board; 20b—backplane;

30b—light guide plate; 31b—main body; 311b—bubbles;

32b—light incident surface; 33b—light emitting surface; 34b—reflective surface.

100c—display device;

10c—light Source Module; 11c—light emitting unit; 12c—circuit board; 20c—backplane;

30c—light guide plate; 31c—main body; 311c—bubbles;

32c—light incident surface; 33c—light emitting surface; 34c—reflective surface.

100d—display device;

10d—light source module; 11d—light emitting unit; 12d—circuit board; 20d—backplane;

30d—light guide plate; 31d—main body; 311d—bubbles;

32d—light incident surface; 33d—light emitting surface; 34d—reflective surface.

100e—display device;

10e—light source module; 11e—light emitting unit; 12e—circuit board; 20e—backplane;

30e—light guide plate; 31e—main body; 311e—bubbles; 312e—central region; 313e—peripheral area;

32e—light incident surface; 33e—light emitting surface; 34e—reflective surface;

100f—display device;

10f—light source module; 11f—light emitting unit; 12f—circuit board; 20f—backplane;

30f—light guide plate; 31f—main body; 311f—bubbles; 312f—central region; 313f—peripheral Region;

32f—light incident surface; 33f—light emitting surface; 34f—Reflective surface.

### DETAILED DESCRIPTION OF ILLUSTRATIVE EMBODIMENTS

In order to make the objectives, technical solution and advantages of the present application more clearly, the technical solution of the present application will be described clearly and completely below with reference to the specific embodiment of the present application and the corresponding drawings. Obviously, the described embodiments are only a part of the embodiments of the present application, but not all of the embodiments. Based on the embodiments in the present application, all other embodiments obtained by those skilled in the art without making creative effort, shall fall within the protection scope of the present application.

The display device in the embodiment of the present application can be a liquid crystal display panel, an Organic Light Emitting Diode (OLED) display device, a Quantum Dot Light Emitting Diode (QLED) display device, a curved display device or other display devices.

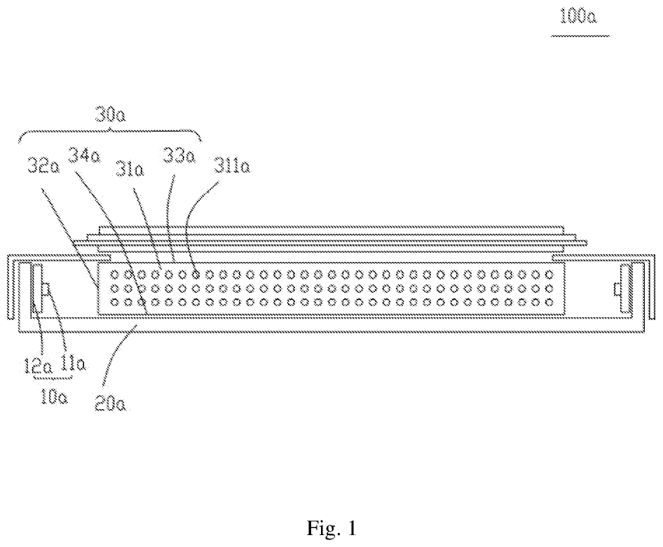

The embodiment of the present application provides a display device 100a. As shown in FIG. 1, the display device 100a includes a light source module 10a, a backplate 20a and a light guide plate 30a.

The light guide plate 30a includes a main body 31a, a light incident surface 32a located at the side of the main body 31a, a light emitting surface 33a located at the top of the main body 32a, and a reflection surface 34a located at the bottom of the main body 31a and opposite to the light emitting surface 33a. In some embodiments, the reflection surface 34a is provided with a plurality of dots or is attached with a reflection sheet. The light incident surface 32a may be located at only one side of the main body 31a, may be symmetrically distributed on opposite sides of the main body 31a, and may even be on side surfaces around the main body 31a. The light source module 10a includes a light emitting unit 11a defined adjacent to the light incident surface 32a of the light guide plate and a circuit board 12a supporting the light emitting unit 11a. The backplate 20a is defined at the bottom of the light guide plate 30a, and the surface of the backplate 20a facing the light guide plate 30a is mirror-treated to reflect light incident on the backplate 20a from the reflective surface 34a onto the light emitting surface 33a of the light guide plate 30a. Mirror surface treatment refers that the surface is smooth and most of the light incident on the surface can be specularly reflected.

In some embodiments of the present application, bubbles 311a are formed in the main body 31a of the light guide plate 30a, and the configuration of the bubbles 311a can reduce the weight of the light guide plate 30a without reducing the thickness of the light guide plate 30a. The thickness of the light guide plate 30a remains unchanged. Most of the light emitted by the light emitting unit 11a can still enter the light guide plate 30a, and the bubbles 311a are defined in the main body 31a, so that the structural strength of the light guide plate 30a will not be greatly reduced. In addition, the bubbles 311a can destroy the total reflection of light in the main body 31a and produce an atomized light emitting effect, so that more light is uniformly emitted from the light emitting surface 33a on the top of the light guide plate 30a. The weight of the display device 100a using the light guide plate 30a is also effectively reduced.

The main body 31a shown in FIG. 1 may have a plurality of uniformly distributed bubbles 311a therein. The diameters of the bubbles 311a in the main body 31a ranges from 0.1 mm to 2 mm, which can be specifically set according to the thickness of the light guide plate 30a and to the weight meant to be reduced. For example, when the thickness of the light guide plate 30a is 4 mm, the diameters of the bubbles 311a may be 0.5 mm. When the thickness of the light guide plate 30a is 6 mm, the diameters of the bubbles 311a may be 0.8 mm. When the thickness of the light guide plate 30a is 9 mm, the diameters of the bubbles 311a may be 1.5 mm.

The space occupied by the bubbles 311a in the main body 31a greatly affects the self-weight of the light guide plate 30a. When the weight meant to be reduced is small, the total volume of the bubbles 311a can be relatively small. When the weight meant to be reduced is larger, the total volume of the bubbles 311a may be larger, but in order to ensure that the light guide plate 30a has a certain strength, the total volume of the bubbles 311a should not be too large. In the present embodiment, the volume ratio of the bubbles 311a to the main body 31a ranges from 1:9 to 4:6. For example, when a small amount of weight reduction is required, the volume ratio of the bubbles 311a to the main body 31a may be 2:8; When substantial weight reduction is required, the volume ratio of the bubbles 311a to the main body 31a may be 3:7.

In the light guide plate 30a in the embodiment of the present application, a proper amount of foaming agent is added into the light guide plate material during the molding process of the light guide plate 30a to generate bubbles 311a. The material of the light guide plate 30a is preferably a polymer material such as poly methyl methacrylate (PMMA) or transparent polycarbonate (PC), so that the foaming agent and the polymer material can be uniformly mixed to form uniformly distributed bubbles 311a in the main body 31a of the light guide plate 30a during the molding process of the light guide plate 30a.

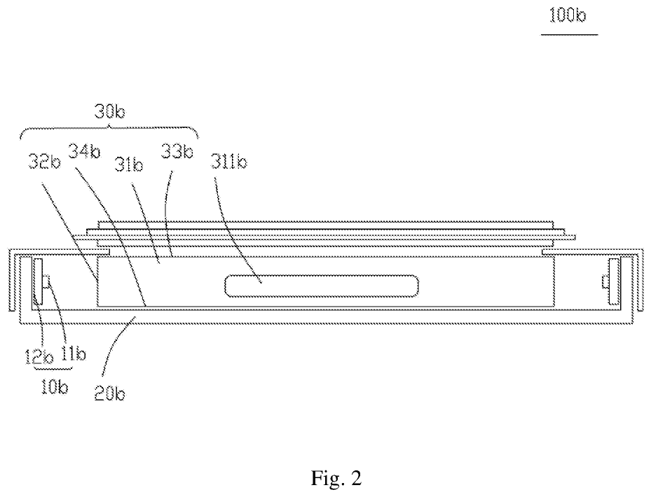

In another embodiment of the light guide plate and display device of the present application, as shown in FIG. 2, the display device 100b includes a light source module 10b, a backplate 20b and a light guide plate 30b.

The light guide plate 30b includes a main body 31b, a light incident surface 32b located on the lateral side of the main body 31b, a light emitting surface 33b located on the top of the main body 32b, and a reflection surface 34b located on the bottom of the main body 31b and defined opposite to the light emitting surface 33b. The light incident surface 32b may be located on only one side of the main body 31b, may be symmetrically distributed on opposite sides of the main body 31b, and may even be on side surfaces around the main body 31b. The light source module 10b includes a light emitting unit 11b defined adjacent to the light incident surface 32b of the light guide plate 30b and a circuit board 12b supporting the light emitting unit 11b. The backplate 20b is defined at the bottom of the light guide plate 30b, and the surface of the backplate 20b facing the light guide plate 30b is mirror-treated to reflect light incident on the backplate 20b from the reflective surface 34b onto the light emitting surface 33b of the light guide plate 30b. Mirror surface treatment refers that the surface is smooth and most of the light incident on the surface can be specularly reflected.

In the embodiment of the present application, bubbles 311b are formed in the main body 31b of the light guide plate 30b, and the arrangement of the bubbles 311b can reduce the weight of the light guide plate 30b without reducing the thickness of the light guide plate 30b. The thickness of the light guide plate 30b remains unchanged, most of the light emitted by the light emitting unit 11b can still enter the light guide plate 30b, and the bubbles 311b are defined in the main body, so that the structural strength of the light guide plate 30b will not be greatly reduced. In addition, the bubbles 311b can destroy the total reflection of light in the main body 31b and produce an atomized light emitting effect, so that more light can be uniformly emitted from the light emitting surface 33b on the top of the light guide plate 30b. The weight of the display device 100b using the light guide plate 30b is also effectively reduced.

The main body 31b may have one bubble 311b inside, i.e., the light guide plate 30b forms a hollow structure. In a direction perpendicular to the reflective surface 34b or the light emitting surface 33b, the bubbles 311b may be circular or rectangular and defined in the center of the main body 31b. For example, the light guide plate 30b has a length of 400 mm and a width of 300 mm, and if the bubbles 311b are circular, the circular diameter may be 50 mm to 100 mm, for example 80 mm. If the bubbles 311b are rectangular, the rectangular bubbles 311b may have a length of 80 mm and a width of 60 mm.

The center line of the bubbles 311b may be centrally defined between the reflective surface 34b and the light emitting surface 33b, or may be defined offset toward the reflective surface 34b.

The thickness of the bubbles is 0.1 mm to 3 mm, depending on the thickness of the light guide plate 30b. The bubbles 311b defined between the reflective surface 34b and the light emitting surface 33b should be kept at a distance from the reflective surface 34b and the light emitting surface 33b so that the light guide plate 30b still has sufficient strength. When the thickness of the light guide plate 30b is 4 mm, the thickness of the bubbles 311b is 0.5 mm to 2 mm, for example 1 mm.

According to the light guide plate 30b of the embodiment of the present application, a proper amount of foaming agent is added into the light guide plate material to generate bubbles 311b during the molding process of the light guide plate 30b. The light guide plate 30B is preferably made of a polymer material such as PMMA or transparent PC.

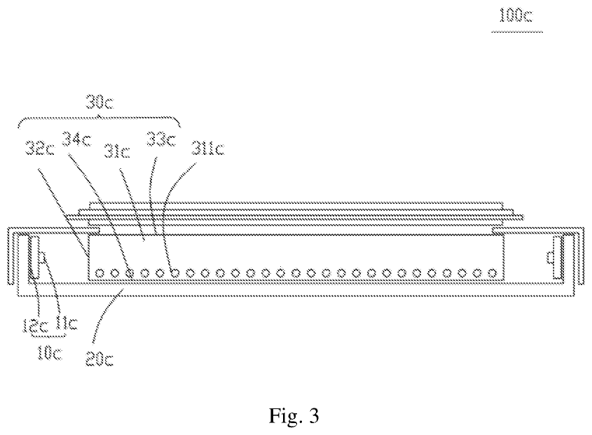

In another embodiment of the light guide plate and display device of the present application, as shown in FIG. 3, the display device 100c includes a light source module 10c, a backplate 20c, a light guide plate 30c and an optical diaphragm set.

The light guide plate 30c includes a main body 31c, a light incident surface 32c located at the side of the main body 31c, a light emitting surface 33c located at the top of the main body 32c, and a reflection surface 34c located at the bottom of the main body 31c and opposite to the light emitting surface 33c. The light incident surface 32c may be located on only one side of the main body 31c, or may be symmetrically distributed on both sides of the main body 31c, or may even be on the side surfaces around the main body 31c. The light source module 10c includes a light emitting unit 11c defined adjacent to the light incident surface 32c of the light guide plate 30c and a circuit board 12c supporting the light emitting unit 11c. In some embodiments, the light emitting unit 11c is an LED and the corresponding light source module 10c is an LED light bar. The backplate 20c is defined at the bottom of the light guide plate 30c, and the surface of the backplate 20c facing the light guide plate 30c is mirror-treated to reflect light incident on the backplate 20c from the reflective surface 34c onto the light emitting surface 33c of the light guide plate 30c. Mirror surface treatment refers that the surface is smooth and most of the light incident on the surface can be specularly reflected. In addition, an optical diaphragm set (not shown in FIG. 3) is located above the light emitting surface 33c of the light guide plate 30c, and may include, for example, an optical diaphragm such as a diffusion sheet.

In the embodiment of the present application, bubbles 311c are formed in the main body 31c of the light guide plate 30c, and the configuration of the bubbles 311c can reduce the weight of the light guide plate 30c without reducing the thickness of the light guide plate 30c. The thickness of the light guide plate 30c remains unchanged. Most of the light emitted by the light emitting unit 11c can still enter the light guide plate 30c, and the bubbles 311c are defined in the main body, so that the structural strength of the light guide plate 30c will not be greatly reduced. In addition, the bubbles 311c can destroy the total reflection of light in the main body 31c and produce an atomized light emitting effect, so that more light can be uniformly emitted from the light emitting surface 33c on the top of the light guide plate 30c. The weight of the display device 100c using the light guide plate 30c is also effectively reduced.

In the present embodiment, the bubbles 311c are located on a layer between the light emitting surface 33c and the reflective surface 34c, and the plurality of bubbles 311c are approximately located on the same plane, which is paralleled to the reflective surface 34c and the light emitting surface 33c and is away from the light emitting surface 33c but near the reflective surface 34c. The bubbles 311c are defined close to the reflective surface 34c, so that light totally reflected in the main body 31c is scattered by the bubbles 311c and emitted from the light emitting surface 33c when approaching the reflective surface 34c, thereby improving the luminous flux on the light emitting surface 33c.

The diameters of the bubbles 311c in the main body 31c ranges from 0.3 mm to 1.5 mm, which can be specifically set according to the thickness of the light guide plate 30c and the weight meant to be reduced. For example, when the thickness of the light guide plate 30c is 5 mm, the diameters of the bubbles 311c may be 0.4 mm. When the thickness of the light guide plate 30c is 6 mm, the diameters of the bubbles 311c may be 1.0 mm. When the thickness of the light guide plate 30c is 10 mm, the diameters of the bubbles 311c may be 1.3 mm.

The space occupied by the bubbles 311c in the main body 31c greatly affects the self-weight of the light guide plate 30c. When the weight meant to be reduced is small, the total volume of the bubbles 311c can be relatively small. When the weight meant to be reduced is large, the total volume of the bubbles 311c may be large, but in order to ensure the light guide plate 30c has a certain strength, the total volume of the bubbles 311c should not be too large. In this embodiment, the volume ratio of the bubbles 311c to the main body 31c ranges from 1:9 to 3:7. For example, when a small amount of weight reduction is required, the volume ratio of the bubbles 311c to the main body 31c may be 1:9; when substantial weight reduction is required, the volume ratio of the bubbles 311c to the main body 31c may be 2:8.

In the light guide plate 30c of the embodiment of the present application, a proper amount of foaming agent is added into the light guide plate material during the molding process of the light guide plate 30c to generate bubbles 311c. The material of the light guide plate 30c is preferably a polymer material such as PMMA or transparent PC.

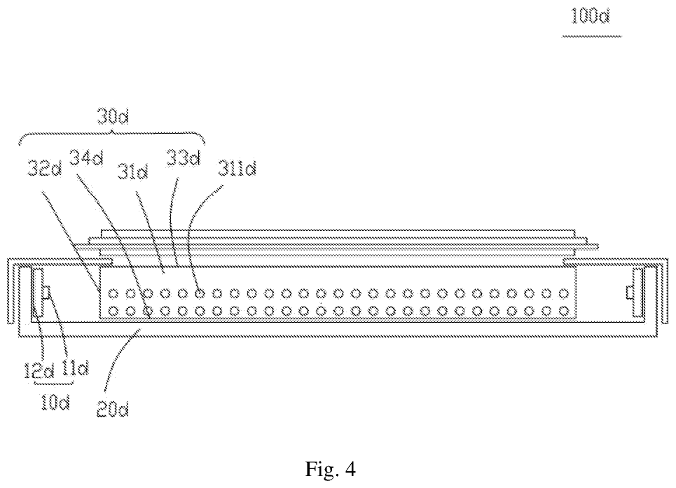

In another embodiment of the light guide plate and display device of the present application, as shown in FIG. 4, the display device 100d includes a light source module 10d, a backplate 20d, a light guide plate 30d and an optical diaphragm set.

The light guide plate 30d includes a main body 31d, a light incident surface 32d located on the lateral side of the main body 31d, a light emitting surface 33d located on the top of the main body 32d, and a reflection surface 34d located on the bottom of the main body 31d and defined opposite to the light emitting surface 33d. The light incident surface 32d may be located on only one side of the main body 31d, may be symmetrically distributed on both sides of the main body 31d, and may even be on the side surfaces around the main body 31d. The light source module 10d includes a light emitting unit 11d defined adjacent to the light incident surface 32d of the light guide plate 30d and a circuit board 12d supporting the light emitting unit 11d. The backplate 20d is defined at the bottom of the light guide plate 30d, and the surface of the backplate 20d facing the light guide plate 30d is mirror-treated so as to reflect light incident on the backplate 20d from the reflective surface 34d onto the light emitting surface 33d of the light guide plate 30d. Mirror surface treatment refers that the surface is smooth and most of the light incident on the surface can be specularly reflected. In addition, an optical diaphragm set (not shown in FIG. 4) is located above the light emitting surface 33d of the light guide plate 30d, and may include, for example, an optical diaphragm such as a diffusion sheet.

In some embodiments of the present application, the bubbles 311d are formed in the main body 31d of the light guide plate 30d, and the arrangement of the bubbles 311d can reduce the weight of the light guide plate 30d without reducing the thickness of the light guide plate 30d. The thickness of the light guide plate 30d remains unchanged. Most of the light emitted by the light emitting unit 11d can still enter the light guide plate 30d, and the bubbles 311d are defined in the main body, which will not greatly reduce the structural strength of the light guide plate 30d. In addition, the bubbles 311d can destroy the total reflection of light in the main body 31d and produce an atomized light emitting effect, so that more light can be uniformly emitted from the light emitting surface 33d on the top of the light guide plate 30d. The weight of the display device 100d using the light guide plate 30d is also effectively reduced.

In the present embodiment, the bubbles 311d are located on two layers between the light emitting surface 33d and the reflective surface 34d, and the plurality of bubbles 311d are respectively located on two mutually paralleled planes. The two mutually paralleled planes are parallelled to the reflective surface 34d and the light emitting surface 33d, and the two mutually paralleled planes are integrally close to the reflective surface 34d and away from the light emitting surface 33d. The bubbles 311d is defined near the reflective surface 34d, so that the light totally reflected in the main body 31d is scattered by the bubbles 311d when approaching the reflective surface 34d and emitted from the light emitting surface 33d, thereby increasing the luminous flux on the light emitting surface 33d.

The diameters of the bubbles 311d in the main body 31d ranges from 0.1 mm to 1.5 mm, which can be specifically set according to the thickness of the light guide plate 30d and the weight meant to be reduced. For example, when the thickness of the light guide plate 30d is 5 mm, the diameters of the bubbles 311d may be 0.5 mm. When the thickness of the light guide plate 30d is 6 mm, the diameters of the bubbles 311d may be 1.0 mm. When the thickness of the light guide plate 30d is 10 mm, the diameters of the bubbles 311d may be 1.2 mm.

The space occupied by the bubbles 311d in the main body 31d greatly affects the self-weight of the light guide plate 30d, and when the weight meant to be reduced is small, the total volume of the bubbles 311d can be relatively small. When the weight meant to be reduced is large, the total volume of the bubbles 311d may be large. But in order to ensure that the light guide plate 30d has a certain strength, the total volume of the bubbles 311d should not be too large. In this embodiment, the volume ratio of the bubbles 311d to the main body 31d ranges from 1:9 to 4:6. For example, when a small amount of weight reduction is required, the volume ratio of the bubbles 311d to the main body 31d may be 1:9. When substantial weight reduction is required, the volume ratio of the bubbles 311d to the main body 31d may be 2:8.

According to the light guide plate 30d of the embodiment of the present application, a proper amount of foaming agent is added into the material of the light guide plate 30d in the molding process of the light guide plate 30d to generate bubbles 311d. The material of the light guide plate 30d is preferably a polymer material such as PMMA or transparent PC.

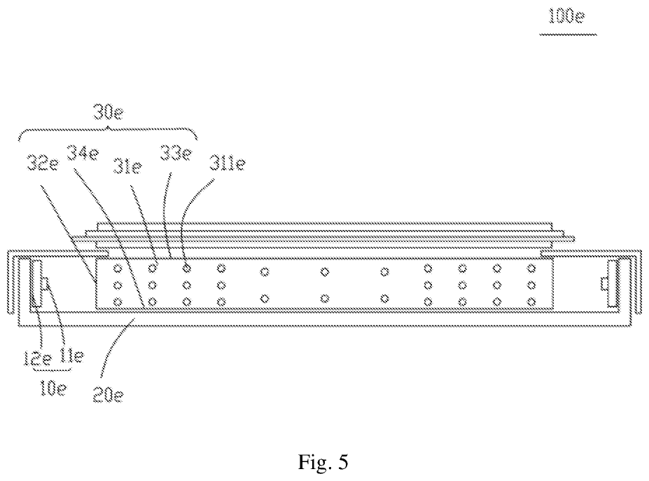

In another embodiment of the light guide plate and display device of the present application, as shown in FIG. 5, the display device 100e includes a light source module 10e, a backplate 20e, a light guide plate 30e and an optical diaphragm set.

The light guide plate 30e includes a main body 31e, a light incident surface 32e located on the lateral side of the main body 31e, a light emitting surface 33e located on the top of the main body 32e, and a reflective surface 34e located on the bottom of the main body 31e and defined opposite to the light emitting surface 33e. The light incident surface 32e may be located on only one side of the main body 31e, or may be symmetrically distributed on both sides of the main body 31e, or may even be on the side surfaces around the main body 31e. The light source module 10e includes a light emitting unit 11e defined adjacent to the light incident surface 32e of the light guide plate 30e and a circuit board 12e supporting the light emitting unit 11e. The backplate 20e is defined at the bottom of the light guide plate 30e, and the surface of the backplate 20e facing the light guide plate 30e is mirror-treated so as to reflect light incident on the backplate 20e from the reflective surface 34e onto the light emitting surface 33e of the light guide plate 30e. Mirror surface treatment refers that the surface is smooth and most of the light incident on the surface can be specularly reflected. In addition, an optical diaphragm set (not shown in FIG. 5) is located above the light emitting surface 33e of the light guide plate 30e, and may include, for example, an optical diaphragm such as a diffusion sheet.

In some embodiments of the present application, the bubbles 311e are formed in the main body 31e of the light guide plate 30e, and the arrangement of the bubbles 311e can reduce the weight of the light guide plate 30e without reducing the thickness of the light guide plate 30e. The thickness of the light guide plate 30e remains unchanged. Most of the light emitted by the light emitting unit 11e can still enter the light guide plate 30e, and the bubbles 311e are defined in the main body, so that the structural strength of the light guide plate 30e will not be greatly reduced. In addition, the bubbles 311e can destroy the total reflection of light in the main body 31e and produce an atomized light emitting effect, so that more light is uniformly emitted from the light emitting surface 33e on the top of the light guide plate 30e. The weight of the display device 100e using the light guide plate 30e is also effectively reduced.

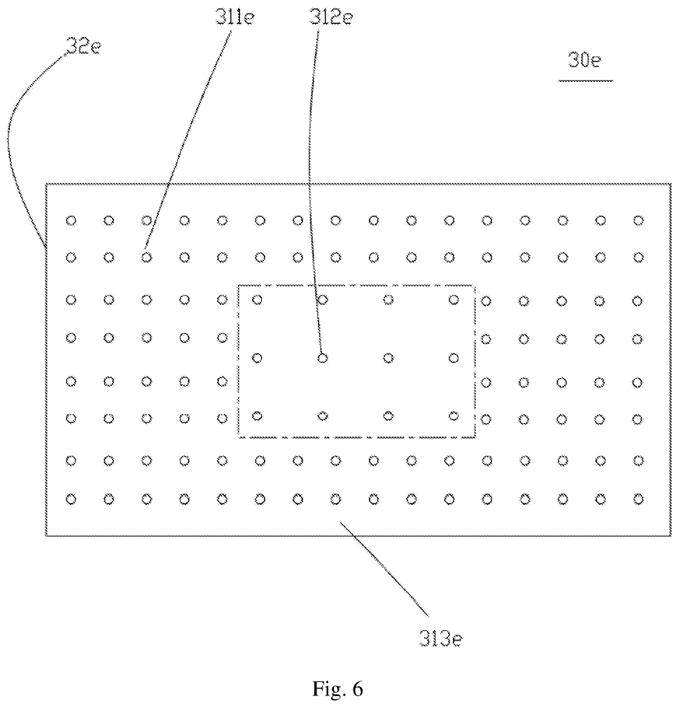

Referring to FIGS. 5 and 6, the main body 31e includes a central region 312e and a peripheral region 313e surrounding the central region 312e. Especially when the thickness of the light guide plate 30e is small and the number of bubbles 311e on the main body 31e will greatly reduce the strength of the light guide plate 30e, the bubbles 311e in the peripheral region 313e may be defined denser than the bubbles 311e in the central region 312e, making the central region 312e have higher strength than the peripheral region 313e.

The central region 312e may be a symmetrical pattern or a special pattern, and the symmetrical pattern may be, for example, a circle or a rectangle. In some embodiments, the central region 312e is rectangular.

The diameters of the bubbles 311e in the main body 31e ranges from 0.1 mm to 1.5 mm, which can be specifically set according to the thickness of the light guide plate 30e and the weight meant to be reduced. For example, when the thickness of the light guide plate 30e is 5 mm, the diameters of the bubbles 311e may be 0.5 mm. When the thickness of the light guide plate 30e is 6 mm, the diameters of the bubbles 311e may be 1.0 mm. When the thickness of the light guide plate 30e is 10 mm, the diameters of the bubbles 311e may be 1.2 mm.

The space occupied by the bubbles 311e in the main body 31e greatly affects the self-weight of the light guide plate 30e, and when the weight meant to be reduced is small, the total volume of the bubbles 311e can be relatively small. When the weight meant to be reduced is large, the total volume of the bubbles 311e may be large, but in order to ensure that the light guide plate 30e has a certain strength, the total volume of the bubbles 311e should not be too large. In this embodiment, the volume ratio of the bubbles 311e to the main body 31e ranges from 1:9 to 4:6. Specifically, the bubble volume ratio of the central region 312e may be 1:9, and the bubble volume ratio of the peripheral region 313e may be 3:7. For example, when a small amount of weight reduction is required, the bubble volume ratio of the central region 312e may be 1:9, and the bubble volume ratio of the peripheral region 313e may be 2:8. When substantial weight reduction is required, the bubble volume ratio of the central region 312e may be 2:8, and the bubble volume ratio of the peripheral region 313e may be 3:7.

The bubbles 311e are located in the main body 31e, and a distance of 2 to 10 mm, for example 5 mm, is defined between the bubbles 311 and the light incident surface 32e.

In the embodiment of the present application, since bubbles 311e are formed in the main body 31e of the light guide plate 30e, the weight of the light guide plate 30e is reduced without reducing the thickness of the light guide plate 30e and without greatly reducing the strength of the light guide plate 30e. The display device 100e configuring the light guide plate 30e is also weight-reduced. Moreover, the bubbles 311e can scatter light as a scattering structure.

In the light guide plate 30e of the embodiment of the present application, a proper amount of foaming agent is added into the light guide plate material in the molding process of the light guide plate 30e to generate bubbles 311e. The material of the light guide plate 30e is preferably a polymer material such as PMMA or transparent PC.

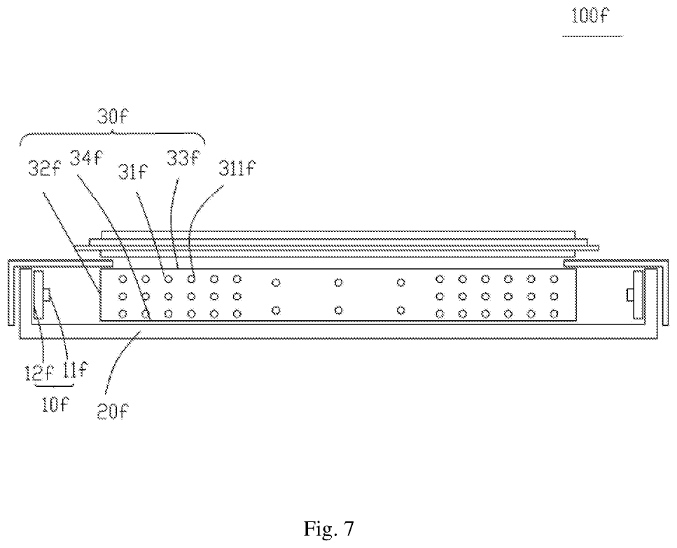

In another embodiment of the light guide plate and display device of the present application, as shown in FIG. 7, the display device 100f includes a light source module 10f, a backplate 20f, a light guide plate 30f and an optical diaphragm set.

The light guide plate 30f includes a main body 31f, a light incident surface 32f located on the lateral side of the main body 31f, a light emitting surface 33f located on the top of the main body 32f, and a reflection surface 34f located on the bottom of the main body 31f and defined opposite to the light emitting surface 33f. The light incident surface 32f may be located on only one side of the main body 31f, may be symmetrically distributed on both sides of the main body 31f, and may even be on the side surfaces around the main body 31f. The light source module 10f includes a light emitting unit 11f defined adjacent to the light incident surface 32f of the light guide plate 30f and a circuit board 12f supporting the light emitting unit 11f. The backplate 20f is defined at the bottom of the light guide plate 30f, and the surface of the backplate 20f facing the light guide plate 30f is mirror-treated so as to reflect light incident on the backplate 20f from the reflective surface 34f onto the light emitting surface 33f of the light guide plate 30f. Mirror surface treatment refers that the surface is smooth and most of the light incident on the surface can be specularly reflected. In addition, the optical diaphragm set (not shown in FIG. 7) is located above the light emitting surface 33f of the light guide plate 30f, and may include, for example, an optical diaphragm such as a diffusion sheet.

In the embodiment of the present application, bubbles 311f are formed in the main body 31f of the light guide plate 30f, and the arrangement of the bubbles 311f can reduce the weight of the light guide plate 30f without reducing the thickness of the light guide plate 30f. The thickness of the light guide plate 30f remains the same, most of the light emitted by the light emitting unit 11f can still enter the light guide plate 30f, and the bubbles 311f are defined in the main body without greatly reducing the structural strength of the light guide plate 30f. In addition, the bubbles 311f has a scattering function, which can destroy the total reflection of light in the main body 31f and produce an atomized light emitting effect, so that more light is uniformly emitted from the light emitting surface 33f on the top of the light guide plate 30f. The weight of the display device 100f using the light guide plate 30f is also effectively reduced.

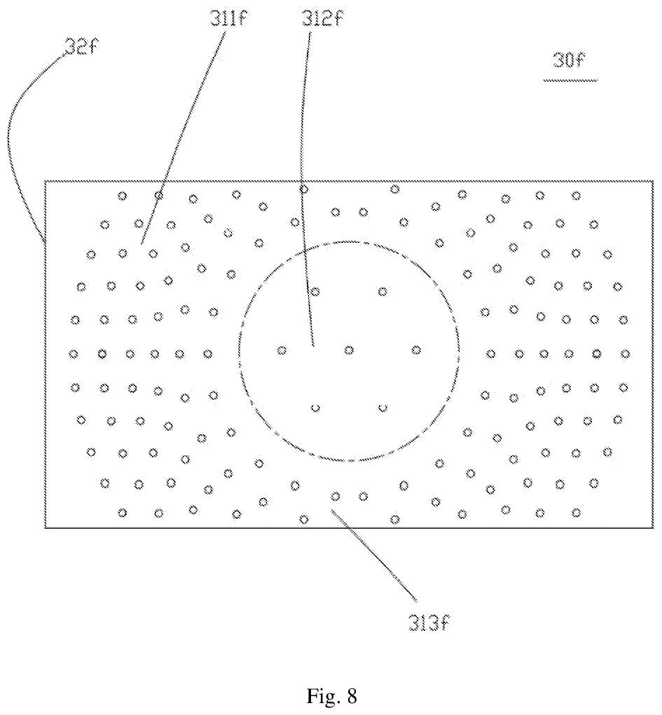

Referring to FIGS. 7 and 8, the main body 31f includes a central region 312f and a peripheral region 313f surrounding the central region 312f. especially when the thickness of the light guide plate 30f is small and the number of bubbles 311f on the main body 31f will greatly reduce the strength of the light guide plate 30f, the bubbles 311f in the peripheral region 313f may be denser than the bubbles 311f in the central region 312f, making the central region 312f have higher strength than the peripheral region 313f.

The central region 312f may be a symmetrical pattern or a special pattern, such as a circle or a rectangle. In this embodiment, the central region 312f is circular.

The diameters of the bubbles 311f in the main body 31f ranges from 0.2 mm to 1.5 mm, which can be specifically set according to the thickness of the light guide plate 30f and the weight meant to be reduced. For example, when the thickness of the light guide plate 30f is 5 mm, the diameters of the bubbles 311f may be 0.4 mm. When the thickness of the light guide plate 30f is 6 mm, the diameters of the bubbles 311f may be 1.2 mm. When the thickness of the light guide plate 30f is 10 mm, the diameters of the bubbles 311f may be 1.4 mm.

The space occupied by the bubbles 311f in the main body 31f greatly affect the self-weight of the light guide plate 30f. When the weight meant to be reduced is small, the total volume of the bubbles 311f can be relatively small. When the weight meant to be reduced is large, the total volume of the bubbles 311f may be large, but in order to ensure that the light guide plate 30f has a certain strength, the total volume of the bubbles 311f should not be too large. In the present embodiment, the volume ratio of the bubbles 311f to the main body 31f ranges from 1:9 to 4:6. Specifically, the bubble volume ratio of the central region 312f may be 1:9, and the bubble volume ratio of the peripheral region 313f may be 3:7. For example, when a small amount of weight reduction is required, the bubble volume ratio of the central region 312f may be 1:9, and the bubble volume ratio of the peripheral region 313f may be 2:8. When substantial weight reduction is required, the bubble volume ratio of the central region 312f can be 2:8, and the bubble volume ratio of the peripheral region 313f can be 3:7.

In some embodiments of the present application, since the bubbles 311f are formed in the main body 31f of the light guide plate 30f, the weight of the light guide plate 30f is reduced without reducing the thickness of the light guide plate 30f and without greatly reducing the strength of the light guide plate 30f. The display device 100f configuring the light guide plate 30f is also weight-reduced.

According to the light guide plate 30f of the embodiment of the present application, a proper amount of foaming agent is added into the light guide plate material in the molding process of the light guide plate 30f to generate bubbles 311f. The material of the light guide plate 30F is preferably polymer material such as PMMA or transparent PC.

Finally, it is worth mentioned that the display devices 100a-100f in the aforementioned embodiment may include structures known to those skilled in the art such as glue frames, front frames, panels, etc. besides the aforementioned light source modules 10a-10f, backplates 20a-20f, side-in light guide plates 30a-30f, and even the optical diaphragm set.

The specific embodiments described aforementioned further illustrate the purpose, technical solution and beneficial effects of the present application. It should be understood that the aforementioned is only a specific embodiment of the present application and is not intended for limitation. Any modification, equivalent replacement, improvement, etc. made within the spirit and principles of the present application should be included in the protection scope of the present application.

What is claimed is:

1. A light guide plate, wherein, the light guide plate comprises:
a main body, in which bubbles are formed;
a light incident surface, located at a lateral side of the main body; and
a light emitting surface, located on the top of the main body.

2. The light guide plate of claim 1, wherein, the bubbles in the main body are uniformly distributed, and diameters of the bubbles are 0.1 mm to 2 mm, a volume ratio of the bubbles to the main body is 1:9 to 4:6.

3. The light guide plate of claim 1, wherein, the main body comprises bubbles making the light guide plate have a hollow structure, in a direction perpendicular to the light emitting surface the bubbles are circular or rectangular, and the bubbles are defined at the center of the main body.

4. The light guide plate of claim 3, wherein, the light guide plate comprises a reflective surface defined opposite to the light emitting surface; a center line of the bubbles are centrally defined between the reflective surface and the light emitting surface; a thickness of the bubbles are 0.1 mm to 3 mm between the reflective surface and the light emitting surface.

5. The light guide plate of claim 3, wherein, the light guide plate comprises a reflective surface defined opposite to the light emitting surface; a center line of the bubbles are defined offset towards a direction of the reflective surface; a thickness of the bubbles are 0.1 mm to 3 mm between the reflective surface and the light emitting surface.

6. The light guide plate of claim 1, wherein, the light guide plate comprises a reflective surface defined opposite to the light emitting surface, the bubbles in the main body are located on a same plane, the plane is paralleled to the light emitting surface, close to the reflective surface and away from the light emitting surface; diameters of the bubbles are 0.3 mm to 1.5 mm, and a volume ratio of the bubbles to the main body is 1:9 to 3:7.

7. The light guide plate of claim 1, wherein, the light guide plate comprises a reflective surface defined opposite to the light emitting surface; the bubbles in the main body are defined on two mutually paralleled planes between the light emitting surface and the reflective surface; the two mutually paralleled planes are paralleled to the light emitting surface and the reflective surface; the two mutually paralleled planes are close to the reflective surface and away from the light emitting surface; diameters of the bubbles are 0.1 mm to 1.5 mm; a volume ratio of the bubbles to the main body is 1:9 to 4:6.

8. The light guide plate of claim 1, wherein, the main body comprises a central region and a peripheral region surrounding the central region, bubbles located in the peripheral region are distributed denser than bubbles located in the central region, diameters of the bubbles are 0.1 mm to 1.5 mm; the central region present as a symmetrical pattern or a specific pattern;
a volume ratio of the bubbles in the peripheral region is 2:8 to 3:7; a volume ratio of the bubbles in the central region is 1:9 to 2:8.

9. The light guide plate of claim 8, wherein, a distance is defined between the bubbles in the main body and the light incident surface, and the distance is 2 to 10 mm; the central region is rectangular or circular.

10. A light guide plate, comprising:
a main body, in which bubbles are formed for reducing weight and atomizing light;
a light incident surface, located at a lateral side of the main body; and
a light emitting surface, located at the top of the main body;
the bubbles are formed by foaming agent.

11. A display device, wherein, the display panel comprises a light guide plate, the light guide plate comprises:
a main body, in which bubbles are formed;
a light incident surface located at a lateral side of the main body; and
a light emitting surface located on the top of the main body.

12. The display device of claim 11, wherein, the bubbles in the main body is uniformly distributed, and diameters of the bubbles are 0.1 mm to 2 mm, a volume ratio of the bubbles to the main body is 1:9 to 4:6.

13. The display device of claim 11, wherein, the main body comprises bubbles making the light guide plate have a hollow structure in a direction perpendicular to the light emitting surface, the bubbles are circular or rectangular, and the bubbles are defined at the center of the main body.

14. The display device of claim 13, wherein, the light guide plate comprises a reflective surface defined opposite to the light emitting surface; a center line of the bubbles are centrally defined between the reflective surface and the light emitting surface, or is defined offset towards a direction of the reflective surface; a thickness of the bubbles are 0.1 mm to 3 mm between the reflective surface and the light emitting surface.

15. The display device of claim 13, wherein, the light guide plate comprises a reflective surface defined opposite to the light emitting surface; a center line of the bubbles are defined offset towards a direction of the reflective surface; a thickness of the bubbles are 0.1 mm to 3 mm between the reflective surface and the light emitting surface.

16. The display device of claim 11, wherein, the light guide plate comprises a reflective surface defined opposite to the light emitting surface, the bubbles in the main body is located on a same plane, the plane is paralleled to the light emitting surface, close to the reflective surface and away from the light emitting surface; diameters of the bubbles are 0.3 mm to 1.5 mm, and a volume ratio of the bubbles to the main body is 1:9 to 3:7.

17. The display device of claim 11, wherein, the light guide plate comprises a reflective surface defined opposite to the light emitting surface; the bubbles in the main body is defined on two mutually paralleled planes between the light emitting surface and the reflective surface; the two mutually paralleled planes are paralleled to the light emitting surface and the reflective surface; the two mutually paralleled planes are close to the reflective surface and away from the light emitting surface; diameters of the bubbles are 0.1 mm to 1.5 mm; a volume ratio of the bubbles to the main body is 1:9 to 4:6.

18. The display device of claim 11, wherein, the main body comprises a central region and a peripheral region surrounding the central region, bubbles located in the peripheral region are distributed denser than bubbles located in the central region, diameters of the bubbles are 0.1 mm to 1.5 mm; the central region is in a symmetrical pattern or a specific pattern;
a volume ratio of the bubbles in the peripheral region is 2:8 to 3:7; a volume ratio of the bubbles in the central region is 1:9 to 2:8.

19. The display device of claim 18, wherein, a distance is defined between the bubbles in the main body and the light incident surface, and the distance is 2 to 10 mm; the central region is rectangular or circular.

20. The display device of claim 11, wherein, the bubbles are formed by forming agent.
